(19) United States
(12) Patent Application Publication
(10) Pub. No.: US 2024/0249441 A1
(43) Pub. Date: Jul. 25, 2024

(54) METHOD, APPARATUS AND MEDIUM FOR POINT CLOUD CODING

(71) Applicants: Beijing Bytedance Network Technology Co., Ltd., Beijing (CN); Bytedance Inc., Los Angeles, CA (US)

(72) Inventors: Yingzhan XU, Beijing (CN); Kai Zhang, Los Angeles, CA (US); Li Zhang, Los Angeles, CA (US)

(21) Appl. No.: 18/627,287

(22) Filed: Apr. 4, 2024

Related U.S. Application Data
(63) Continuation of application No. PCT/CN2022/121855, filed on Sep. 27, 2022.

(30) Foreign Application Priority Data
Oct. 4, 2021 (WO) PCT/CN2021/122507

(51) Int. Cl. G06T 9/40

(52) U.S. Cl. CPC G06T 9/40

(57) ABSTRACT

Embodiments of the present disclosure provide a solution for point cloud coding. A method for point cloud coding is proposed. The method comprises: determining, during a conversion between a current PC sample of a point cloud sequence and a bitstream of the point cloud sequence, one or multiple reference PC samples for the current PC sample, wherein at least one reference frame comprising the one or multiple reference PC samples and a current frame comprising the current PC sample are in a GOF; and performing the conversion based on the one or multiple reference PC samples.

### CROSS REFERENCE TO RELATED APPLICATIONS

This application is a continuation of International Application No. PCT/CN2022/121855, filed on Sep. 27, 2022, which claims the benefit of International Application No. PCT/CN2021/122507 filed on Oct. 4, 2021. The entire contents of these applications are hereby incorporated by reference in their entireties.

### FIELD

Embodiments of the present disclosure relates generally to point cloud coding techniques, and more particularly, to coding and encapsulation of coding parameters in point cloud coding.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

In a first aspect, a method for point cloud coding is proposed. The method comprises: determining, during a conversion between a current point cloud (PC) sample of a point cloud sequence and a bitstream of the point cloud sequence, one or multiple reference PC samples for the current PC sample, wherein at least one reference frame comprising the one or multiple reference PC samples and a current frame comprising the current PC sample are in a group of frames (GOF); and performing the conversion based on the one or multiple reference PC samples. According to the method in accordance with the first aspect of the present disclosure, a hierarchical GOF structure is proposed to perform the inter prediction for geometry coding and attribute coding. One or multiple reference PC samples in the same GOF as the current PC sample may be used for the current PC sample, which improves prediction accuracy and increases the coding efficiency. Moreover, the one or more reference PC samples may have later or earlier time stamps than the current frame, which also causes the coding performance to be improved.

In a second aspect, an apparatus for processing point cloud data is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, a non-transitory computer-readable recording medium is proposed. The non-transitory computer-readable recording medium stores a bitstream of a point cloud sequence which is generated by a method performed by a point cloud processing apparatus. The method comprises: determining one or multiple reference point cloud (PC) samples for a current PC sample of the point cloud sequence, wherein at least one reference frame comprising the one or multiple reference PC samples and a current frame comprising the current PC sample are in a GOF; and generating the bitstream based on the one or multiple reference PC samples.

In a fifth aspect, a method for storing a bitstream of a point cloud sequence is proposed. The method comprises: determining, one or multiple reference point cloud (PC) samples for a current PC sample of the point cloud sequence, wherein at least one reference frame comprising the one or multiple reference PC samples and a current frame comprising the current PC sample are in a GOF; and generating the bitstream based on the one or multiple reference PC samples; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system 100 that may utilize the techniques of the present disclosure;

FIG. 2 illustrates a block diagram that illustrates an example point cloud encoder 200 in accordance with some embodiments of the present disclosure;

FIG. 3 illustrates a block diagram that illustrates an example point cloud decoder 300 in accordance with some embodiments of the present disclosure;

FIG. 4 illustrates a schematic diagram illustrates an example 400 of inter prediction for predictive geometry coding;

FIG. 5 illustrates a schematic diagram illustrates an example 500 of Group of Frame (GOF) structure with a GOF size of 8;

FIG. 6 illustrates a schematic diagram illustrates an example 600 of hierarchical reference relationship of one GOF;

FIG. 7 illustrates a schematic diagram illustrates another example 700 of hierarchical reference relationship of one GOF;

FIG. 8 illustrates a schematic diagram illustrates an example 800 of deriving a prediction direction of child nodes;

FIG. 9 illustrates a flowchart of a method 900 for point cloud coding in accordance with some embodiments of the present disclosure; and

FIG. 10 illustrates a block diagram of a computing device 1000 in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

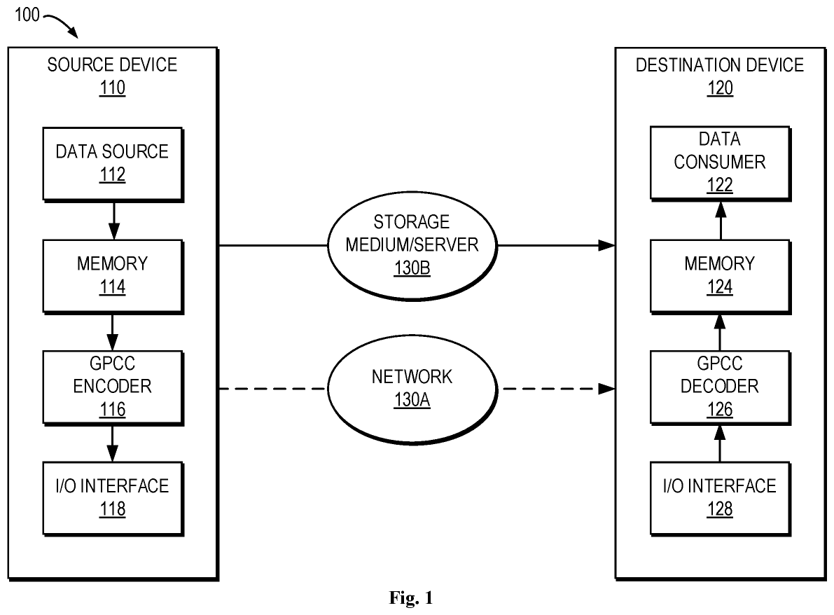

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

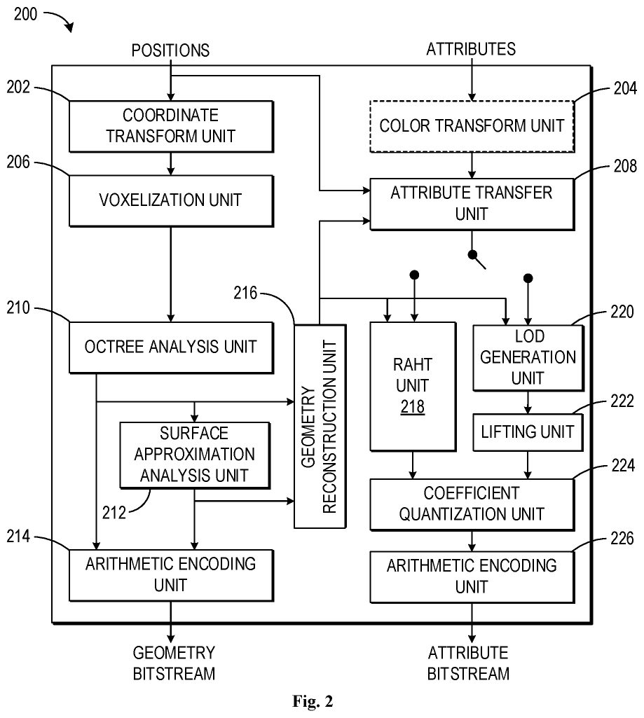

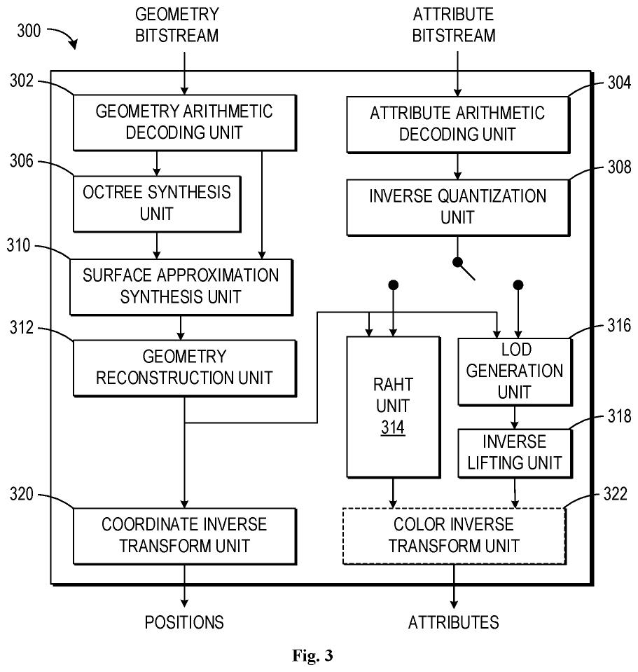

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Summary

This invention is related to point cloud coding technologies. Specifically, it is about coding and encapsulation of coding parameters in point cloud coding. The ideas may be applied individually or in various combination, to any point cloud coding standard or non-standard point cloud codec, e.g., the being-developed Geometry based Point Cloud Compression (G-PCC).

### 2. Abbreviations

G-PCC Geometry based Point Cloud Compression
MPEG Moving Picture Experts Group
3DG 3D Graphics Coding Group
CFP Call for Proposal
V-PCC Video-based Point Cloud Compression
CE Core Experiment
EE Exploration Experiment
inter-EM inter Exploration Model
GOF Group of Frame
RDO Rate Distortion Optimization
GM Global Motion
QP Quantization Parameter
RA Random Access
FIFO First In First Out
OC Occupancy Code
POC Picture Order Count
PC Point Cloud

### 3. Background

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions.

To explore the future point cloud coding technologies in G-PCC, Core Experiment (CE) 13.5 and Exploration Experiment (EE) 13.2 were formed to develop inter prediction technologies in G-PCC. Since then, many new inter prediction methods have been adopted by MPEG and put into the reference software named inter Exploration Model (inter-EM).

In one point cloud frame, there are many data points to describe the 3D objects or scenes. For each data point, there may be corresponding geometry information and attribute information. Geometry information is used to record the spatial location of the data point. Attribute information is used to record more details of the data point, such as texture, normal vector and reflection. In inter-EM, there are some optional tools to support the inter prediction coding and decoding of geometry information and attribute information respectively.

For attribute information, the codec uses the attribute information of the reference points to perform the inter prediction for each point in current frame. The reference points are selected from the data points in current frame and reference frame based on the geometric distance of points. Each reference point corresponds to one weight value which is based on the geometric distance from the current point. The predicted attribute value can be the weighted average value of or one of the attribute values of the reference points. The decision on predicted attribute value is based on Rate Distortion Optimization (RDO) methods.

For geometry information, there are two main methods to perform the inter prediction coding, which are octree based method and predictive tree based method.

In the first method, the geometry information is represented by octree structures and the occupancy code (OC) of each node. For each node in the octree of the current frame, the codec will decide whether to perform octagonal division or not based on the number of points in the current node. The same division will be performed on the corresponding reference node in the reference frame. At the same time, the occupancy codes of the current node and the reference node will be calculated. The codec will use the occupancy code of the reference node to perform the prediction coding for the occupancy code of the current node.

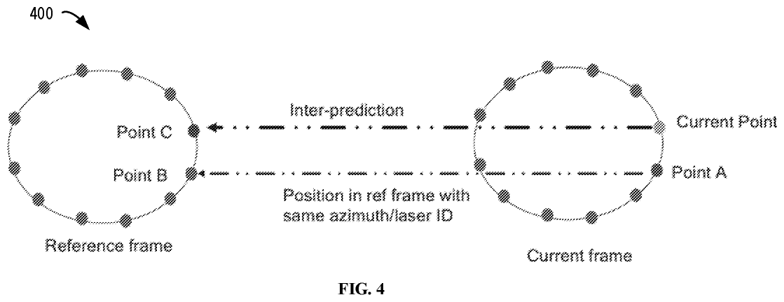

In the second method, the points in the point cloud are sorted to form a predictive tree. As shown in FIG. 4, for each point, the previous decoded point will be chosen as point A. Then the point in the reference frame with the same scaled azimuth and laser ID as point A will be selected as point B. At last, the point in the reference frame which is the first point that has scaled azimuth greater than that of point B will be chosen as point C. The codec will use the geometry information of the point C to perform the prediction coding for the geometry information of the current point.

In current inter-EM, the IPPP GOF structure is applied which means that the reference frame of the current frame is the previous frame if the current frame applies inter prediction. At the same time, inter-EM uses quantization parameters (QP) to control the bit rate points and all frames share the same QP values.

### 4. Problems

The existing designs for inter prediction for point cloud compression have the following problems:
1. In current inter-EM, there is only one reference frame for each frame to perform inter prediction. In theory, the more reference information, the more accurate the prediction results. Using one only reference frame will limit the prediction accuracy and affect the coding efficient.
2. In current inter-EM, the reference frame can only be the frame with the earlier time stamp (i.e., smaller POC values). The purpose of inter prediction is to eliminate redundant information between consecutive frames. However, the redundant information exists not only between the previous frames and the current frame, but also exists between the current frame and the following frames. Only using the frames with earlier time stamps will limit the coding performance.
3. In current inter-EM, the QP value for each frame is the same. However, some frames are the reference frames of other frames, which means the coding priority of them should be higher. In the case of limited transmission resources, they should be assigned a lower QP value to ensure that they can be transmitted more accurately. Applying the same coding accuracy for all frames will affect the coding performance when the transmission resources are very limited.

### 5. Detailed Descriptions

To solve the above problems and some other problems not mentioned, methods as summarized below are disclosed. The embodiments of the present disclosure should be considered as examples to explain the general concepts and should not be interpreted in a narrow way. Furthermore, these inventions can be applied individually or combined in any manner.

In the following discussions, the term “PC sample” refer to the unit that performs prediction coding in the point cloud sequence coding, such as frame/picture/slice/tile/subpicture/node/point/other units that contains one or more nodes or points.
1) It is proposed to divide the frames into one or multiple groups of frames (GOF) in one point cloud sequence to perform point cloud compression.
   a. In one example, N consecutive frames in time stamp order may be clustered as one GOF.
      i. In one example, each frame may belong to one GOF.
      ii. In one example, N may be equal to the GOF size.
   b. In one example, the first frame of a GOF in decoding order may be an I-frame.
      i. In one example, there may be only intra prediction for I-frame.
   c. In one example, the first frame of a GOF in decoding order may not be an I-frame.
      i. In one example, the first frame of a GOF in decoding order may be a P-frame.
      ii. In one example, the first frame of a GOF in decoding order may be a P-frame or a B frame with all reference frames ahead of the current frame in the time stamp order.
   d. Whether to code the first frame of a GOF in decoding order with I-frame may depend on the intra period//random access period.
   e. In one example, the GOF size may be equal to the intra period/random access period.
   f. In one example, the GOF size may be smaller than the intra period/random access period.
   g. In one example, indication of the GOF size and/or coding structure within a GOF may be signalled.
2) It is proposed to use one or multiple reference PC samples to perform the inter prediction for a current PC sample.
   a. In one example, there may be one or multiple reference PC samples for a current PC sample.
   b. In one example, the multiple reference PC samples may be from different reference slices/frames.
      i. Alternatively, the multiple reference PC samples may be from a same reference slices/frame.
   c. In one example, the reference PC sample may be from the same slices/frames as the current PC sample.
   d. Alternatively, furthermore, indication of whether to use multiple reference PC samples may be signalled to the decoder.
   e. In one example, the reference information of a current PC sample (e.g., where the reference PC samples are from and/or which reference PC sample to be used) may be derived at the decoder.
   f. In one example, the reference information of a current PC sample (e.g., where the reference PC samples are from and/or which reference PC sample to be used) may be signalled to the decoder.
      i. In one example, the reference direction may be signaled.
         (1) In one example, the reference direction may include:
         a) The reference direction may be uni-prediction from a reference frame in a first reference list (denoted as L0).
         b) The reference direction may be uni-prediction from a reference frame in a second reference list (denoted as L1).
         c) The reference direction may be bi-prediction (a first reference frame in L0 and a second reference frame in L1).
         (2) In one example, the relative positions of reference frames in reference list may be fixed for a specific frame within one GOF.
         a) In one example, the previously coded N (e.g., N=2) frames in displayer order may be utilized as reference frames.
         i. Alternatively, furthermore, indication of N may be signalled.
         ii. Alternatively, furthermore, the N frames are consecutively previously coded frames right before the specific current frame.
         b) In one example, the relative positions of reference frames in reference lists may be adaptive for a specific frame in a GOF. For example, the positions may be derived based on the GOF size.
         (3) In one example, the reference direction may be conditionally signalled, e.g., according to reference picture list information.
      ii. In one example, indication of the reference frame where the reference PC samples are from may be signaled.
         (1) Indication of the reference frame may be signaled as a reference list index (L0 or L1) and a reference frame index in the reference list.
         a) Alternatively, it may be signalled by reference direction and reference frame index for each direction, if needed.
         (2) The reference list index may be conditionally signaled.
         a) Signaling of the reference list index may be skipped if there is only one reference list.
         (3) The reference frame index for a reference list may be conditionally signaled.
         a) Signaling of the reference frame index may be skipped if there is only one reference frame in the reference list.
      iii. Alternatively, furthermore, indication of the number of reference PC samples may be signalled to the decoder.
      iv. Furthermore, for a sample, at least one indication referring to at least one reference PC sample may be signalled to the decoder to indicate the reference relationship.
         (1) The indication may be conditionally signalled, e.g., depending on whether to use other samples rather than the previous one sample as the reference PC samples.
         (2) The indication may be represented by some indices (e.g., sample id) which indicated the associated sample to be used as the reference PC samples.
         (3) The indication may be coded with fixed-length coding, unary coding, truncated unary coding, etc. al.
         (4) The indication may be coded in a predictive way.
      v. In one example, at least one reference sample.
   g. In one example, the geometry information of the reference PC samples may be used to perform the geometry inter prediction for the current PC sample.
      i. In one example, the geometry information of the reference PC samples may be used to derive the predicted geometry value of the current PC sample.
         (1) In one example, the predicted geometry value may be selected from some candidate predictors.
         a) A candidate predictor may be derived by one or multiple geometry values of the reference samples.
         b) A candidate predictor may be derived as a function of one or multiple geometry values of the reference PC samples.
         c) A candidate predictor may be derived by one or multiple predicted geometry values of the current PC sample or previous decoded samples.
         d) A candidate predictor may be derived as a function of one or multiple predicted geometry values of the current PC sample or previous decoded samples.
         (2) In one example, the candidate predictors may include but not limit to the average value, the weighted average value, one of the geometry information of the reference PC samples, etc. al.
         (3) In one example, the selection of the predictors may be based on rate optimization method, distortion optimization method, RDO method, etc. al.
         (4) In one example, the selection may be derived at the decoder.
         (5) In one example, for each sample, the indication referring to the selected predictor may be signalled to the decoder.
         a) The indication may be coded with fixed-length coding, unary coding, truncated unary coding, etc. al.
         b) The indication may be coded in a predictive way.
         (6) In one example, the residual between the predicted geometry information and real geometry information may be derived and signalled to the decoder.
         a) The residual may be coded with fixed-length coding, unary coding, truncated unary coding, etc. al.
         b) The residual may be coded in a predictive way.
      ii. In one example, the geometry information of the reference PC samples may be used as the contextual information for the predictive coding of the geometry information of the current node.
   h. In one example, the attribute information of the reference PC samples may be used to perform the attribute inter prediction for the current PC sample.
      i. In one example, the attribute information of the reference PC samples may be used to derive the predicted attribute value of the current PC sample.
         (1) In one example, the predicted attribute value may be selected from some candidate predictors.
         a) A candidate predictor may be derived by one or multiple attribute values of the reference PC samples.
         b) A candidate predictor may be derived as a function of one or multiple attribute values of the reference PC samples.
         c) A candidate predictor may be derived by one or multiple predicted attribute values of the current PC sample or previous decoded samples.
         d) A candidate predictor may be derived as a function of one or multiple predicted attribute values of the current PC sample or previous decoded samples.
         (2) In one example, the candidate predictors may include but not limit to the average value, the weighted average value, one of the attribute information of the reference PC samples, etc. al.
         (3) In one example, the selection of the predictors may be based on rate optimization method, distortion optimization method, RDO method, etc. al.
         (4) In one example, the selection may be derived at the decoder.
         (5) In one example, for each sample, the indication referring to the selected predictor may be signalled to the decoder.
         a) The indication may be coded with fixed-length coding, unary coding, truncated unary coding, etc. al.
         b) The indication may be coded in a predictive way.
         (6) In one example, the residual between the predicted attribute information and real attribute information may be derived and signalled to the decoder.
         a) The residual may be coded with fixed-length coding, unary coding, truncated unary coding, etc. al.
         b) The residual may be coded in a predictive way.
      ii. In one example, the attribute information of the reference PC samples may be used as the contextual information for the predictive coding of the attribute information of the current node.
3) The sample in a frame with a later time stamp may be used as the reference PC sample for the current PC sample.
   a. In one example, there is time stamp information for each frame in one timed point cloud sequence.
   b. In one example, the time stamp order may be the same as the displaying order.
   c. In one example, the time stamp order may be the same as the rendering order.
   d. In one example, the time stamp of each sample is equal to the time stamp of the frame it belonging to.
   e. In one example, the sample with an earlier time stamp may be used as the reference PC sample for the current PC sample.
   f. In one example, the sample with the same time stamp may be used as the reference PC sample for the current PC sample.
   g. In one example, the sample with a later time stamp may be used as the reference PC sample for the current PC sample.
   h. Alternatively, furthermore, indication of whether to allow using the sample with a later time stamp as the reference PC sample may be signalled to the decoder.
4) In one example, there may be a low-delay mode for point cloud compression.
   a. Alternatively, furthermore, with the low-delay mode, the time stamp order and the decoding order must be the same.
   b. Alternatively, furthermore, indication of whether to use low-delay mode may be signalled to the decoder.
   c. Alternatively, furthermore, multiple reference frames may be used for the low-delay mode.
5) It is proposed to use the sample in the frame with an earlier time stamp or the same time stamp as the reference sample in low delay mode.
   a. In one example, the sample with an earlier time stamp may be used as the reference PC sample for the current PC sample in low delay mode.
   b. In one example, the sample with the same time stamp may be used as the reference PC sample for the current PC sample in low delay mode.
6) It is proposed to perform the encoding and decoding process based on the reference relationship but not the time stamp order of samples.
   a. In one example, the reference PC samples may be encoded before the current PC sample.
   b. In one example, the reference PC samples may be decoded before the current PC sample.
7) For an inter-coded slice/frame wherein inter prediction is enabled, the information of reference frames may be signaled.
   a. The information of reference frames may comprise,
      i. Number of reference frames.
      ii. Number of reference lists.
      iii. Number of reference frames in each reference list.
      iv. Reference frames in each reference list.
         (1) A reference frame may be indicated by its time stamp or POC or other ways.
   b. The information may be shared by multiple frames, such as signalled in a higher-level syntax structure (e.g., in SPS/PPS).
8) It is proposed to code PC samples in different orders instead of being in a fixed order and/or different coding accuracies of PC samples.
   a. In one example, it is proposed to apply hierarchical coding accuracy based on the coding priorities of the PC samples.
      i. In one example, the PC samples may have different coding priorities in one point cloud sequence.
b. In one example, the coding priority of the reference PC sample should be higher than the current PC sample.
c. In one example, the coding accuracy of the sample with higher coding priority should be higher than the sample with lower coding priority.
d. In one example, the coding accuracy may be controlled be the QP value/quantization step in point cloud sequence coding.
e. In one example, the QP/quantization step value for the reference PC sample may be lower/smaller than the current PC sample.
   f. In one example, the delta value of the QP/quantization step value for the reference PC sample may be fixed.
   g. In one example, the delta value of the QP/quantization step value for the reference PC sample may be derived at the decoder.
      i. In one example, the delta value of the QP/quantization step value for the reference PC sample may be derived based on the GOF size.
      ii. In one example, the delta value of the QP/quantization step value for the reference PC sample may be derived based on the intra period/random access period.
      iii. In one example, the delta value of the QP/quantization step value for the reference PC sample may be derived based on the indicators of lossless coding mode.
      iv. In one example, the delta value of the QP/quantization step value for the reference PC sample may be derived based on the indicators of low delay coding mode.
   h. In one example, the delta value of the QP/quantization step value for the reference PC sample may be signalled to the decoder.
   i. In above examples, the “reference PC sample” may be replaced by “current PC sample”.
   j. Alternatively, furthermore, indication of whether to use hierarchical QP values and/or QP values/quantization steps may be signalled to the decoder.
   k. In one example, the QP value for each sample may be derived at the decoder.
9) In one example, the QP value for each frame/block/cube/tile/slice may be signalled to the decoder.
   a. The QP value may be coded with fixed-length coding, unary coding, truncated unary coding, etc. al.
   b. The QP value may be coded in a predictive way.
10) It is proposed to use the occupancy information of multiple reference nodes to perform the inter prediction for the current node when using octree geometry coding.
   a. In one example, the geometry information may be represented by the octree structure and the occupancy information (such as occupancy code) of octree nodes when using octree geometry coding.
   b. In one example, for each frame, there may be multiple reference frames.
   c. Alternatively, furthermore, indication of whether to use multiple reference frames may be signalled to the decoder.
   d. In one example, for each node, there may be at least one corresponding reference node in each reference frame.
   e. In one example, for each node, the reference occupancy code may be selected from some candidate values.
      i. A candidate value may be derived by the occupancy information of one or multiple reference nodes.
      ii. A candidate value may be derived as a function of the occupancy information of one or multiple reference nodes.
      iii. In one example, the candidate values may include but not limit to the XOR, same or, one of the occupancy information of the reference nodes.
      iv. In one example, the selection of the candidate values may be based on rate optimization method, distortion optimization method, RDO method, etc. al.
      v. In one example, the selection may be derived at the decoder.
      vi. In one example, the indication referring to the selected candidate value may be signalled to the decoder.
         (1) The indication may be coded with fixed-length coding, unary coding, truncated unary coding, etc. al.
         (2) The indication may be coded in a predictive way.
   f. In one example, for each node, the reference occupancy code may be used as the predicted occupancy information.
      i. Furthermore, the residual between the predicted occupancy information and the real occupancy information may be derived and signalled to the decoder.
         (1) The residual may be coded with fixed-length coding, unary coding, truncated unary coding, etc. al.
         (2) The residual may be coded in a predictive way.
   g. In one example, for each node, the reference occupancy information may be used as the contextual information for the predictive coding of the occupancy information of the current node.
11) It is proposed to derive the selections of reference occupancy information for the child nodes based on the current node and reference nodes of the current nodes when using octree geometry coding.
   a. In one example, the geometry information may be represented by the octree structure and the occupancy information (such as occupancy code) of octree nodes when using octree geometry coding.
   b. In one example, for each node, there may be one occupancy code, which is an 8-bit binary number. Each bit corresponds to one child node.
   c. In one example, for each node, there may be multiple reference nodes and corresponding occupancy codes.
   d. In one example, for each node, there may be one reference occupancy code.
   e. In one example, for each node, the reference occupancy code may be selected from one of occupancy codes of the reference nodes.
   f. In one example, for each node, the selection of reference occupancy code of the child nodes may be derived based on the occupancy codes of the current node and the reference nodes of the current node.
      i. In one example, for each bit in the occupancy codes of the current node and the reference nodes of the current node:
         (1) If the bit values are the same at the same bit location for current node and one reference node, the occupancy code of the child node of the reference node may be selected as the reference occupancy code of the child node of the current node. The child node corresponds to the bit location.
      ii. In one example, the numbers of the mismatched bits between the occupancy codes of the current node and the reference nodes of the current nodes are calculated:
         (1) If the numbers of the mismatched bits are the same for all reference nodes, the selection of child node may inherit the selection of the current node.
         (2) If the numbers of the mismatched bits are not same for all reference nodes, the occupancy code of the child node of the reference node, which has the least mismatching number, may be selected as the reference occupancy code of the child node.
12) It is proposed to select the reference points from different reference PC samples for the current PC point to perform the attribute inter prediction.
   a. In one example, for each point, there may be multiple reference points to perform attribute inter prediction.
   b. In one example, the reference points may be selected from multiple samples based on the geometry distance between the reference point and the current point.
   c. In one example, the attribute information of the reference points may be used to derive the predicted attribute value of the current point.
   d. In one example, the predicted attribute value may be selected from some candidate predictors.
      i. A candidate predictor may be derived by attribute information of reference points from one or multiple reference PC samples.
      ii. A candidate predictor may be derived as a function of attribute information of reference points from one or multiple reference PC samples.
      iii. In one example, the candidate predictors may include but not limit to the average value, the weighted average value, one of the attribute information of the reference points, etc. al.
         (1) In one example, the weight of each reference point may be the geometry distance from the current point.
      iv. In one example, the selection of the predictors may be based on rate optimization method, distortion optimization method, RDO method, etc. al.
      v. In one example, for each point, the indication referring to the selected predictor may be signalled to the decoder.
         (1) The indication may be coded with fixed-length coding, unary coding, truncated unary coding, etc. al.
         (2) The indication may be coded in a predictive way.
   e. In one example, the residual between the predicted attribute value and real attribute value may be derived and signalled to the decoder.
      i. The residual may be coded with fixed-length coding, unary coding, truncated unary coding, etc. al.
      ii. The residual may be coded in a predictive way.
   f. In one example, the predicted attribute value may be used as the contextual information for the predictive coding of the attribute information of the current point.

### 6. Embodiments

1) This embodiment describes an example of how to use two reference frames and use the frame with later time stamps as reference frames to perform inter prediction for the current frame.

In the example, the point cloud frames in the point cloud sequence are divided in multiple GOFs and the GOF size is set to 8.

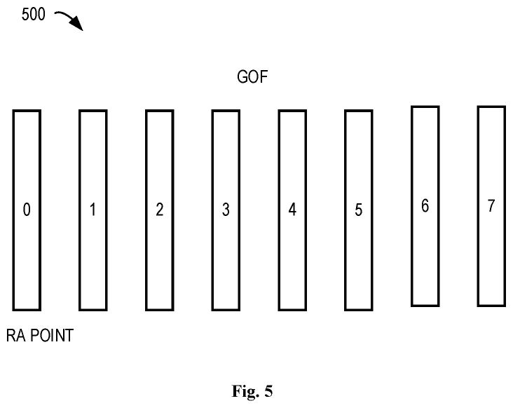

As shown in FIG. 5, for each GOF, there are 8 consecutive frames in time stamp order. The numbers in FIG. 5 indicate the relative timestamp order of the frames in the GOF. The frame “0” is the first frame in the GOF which means it has the earliest timestamp in the GOF.

The first frame is the random access (RA) point which means that there is only intra prediction coding but no inter prediction coding.

For the other 7 frames, both the intra prediction coding and inter prediction coding will be performed based on the reference relationship.

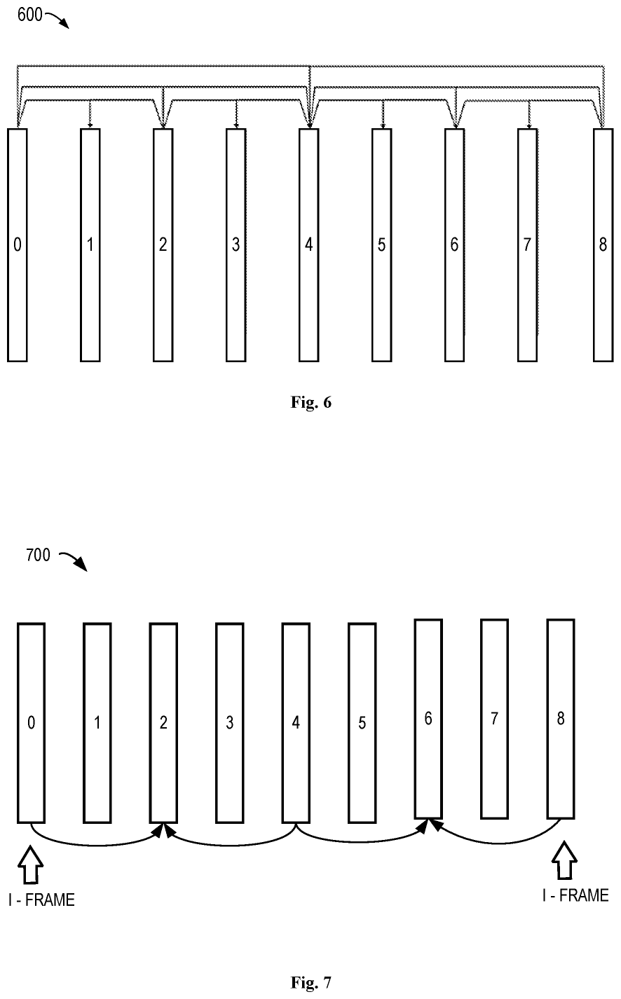

As shown in FIG. 6, a hierarchical reference relationship is applied for each GOF. In FIG. 6, the frame “8” is the first frame of the next GOF.

For frame “1”˜“7”, each frame has two reference frames. One reference frame has an earlier time stamp than the current frame and another reference frame has a later time stamp than the current frame. For each frame, the reference frames are shown in Table 1.

TABLE 1
Reference frames for each frame in one GOF

| Frame time stamp | 0 | 1 | 2 | 3 | 4 | 5 | 6 | 7 |
|---|---|---|---|---|---|---|---|---|
| Reference frame time | None | 0, 2 | 0, 4 | 2, 4 | 0, 8 | 4, 6 | 4, 8 | 6, 8 |
| stamp | | | | | | | | |

To make sure that the reference frames are encoded and decoded before the current frames, the encoding and decoding order for frame “0” ˜ “8” are {0, 8, 4, 2, 1, 3, 6, 5, 7}.

It should be noticed that the frame “8” is the first frame of the next GOF, but it should be processed before the frame “1”˜“7”. And if the frame “8” was encoded or decoded in the current GOF, the processing for the frame “8” which is also the frame “0” in the next GOF should be skipped in the next GOF.
2) This embodiment describes an example of how to apply hierarchical coding accuracy for attribute inter prediction based on the coding priorities of the samples.

In the example, the point cloud frames in the point cloud sequence are divided in multiple GOFs and the GOF size is set to 8. As shown in FIG. 6, the hierarchical reference relationship is applied.

The hierarchical coding priorities are calculated based on the principle that the reference frame has higher coding priority than the current frame. The coding priorities results are shown in Table 2.

TABLE 2
Coding priority for each frame in one GOF

| Frame time | | | | | | | | | |
|---|---|---|---|---|---|---|---|---|---|
| stamp | 0 | 1 | 2 | 3 | 4 | 5 | 6 | 7 | 8 |
| Coding priority | 4 | 1 | 2 | 1 | 3 | 1 | 2 | 1 | 4 |

In the example, QP value is used to control the coding accuracy. The lower the QP value, the higher the coding accuracy. Thus, a hierarchical QP values structure is applied to frames so that the coding accuracy can be changes based on the coding priority.

For each frame, the QP value is calculated as:

$${QP}_{real} = {QP}_{original} + QP\_shift$$

The QP_shift values for each frame are shown in Table 3.

TABLE 3
QP_shift value for each frame in one GOF

| Frame time | | | | | | | | | |
|---|---|---|---|---|---|---|---|---|---|
| stamp | 0 | 1 | 2 | 3 | 4 | 5 | 6 | 7 | 8 |
| QP_shift | 0 | +3step | +2step | +3step | +step | +3step | +2step | +3step | 0 |

The parameter step is one non-negative number that is used to control the change scale of the hierarchical QP value. In test, it can be 2/3/4, etc. al.

For example, when step is set to 3, the QP_shift values for each frame are shown in Table 4.

TABLE 4
QP_shift value for each frame in one GOF when step = 3

| Frame time | | | | | | | | | |
|---|---|---|---|---|---|---|---|---|---|
| stamp | 0 | 1 | 2 | 3 | 4 | 5 | 6 | 7 | 8 |
| QP_shift | 0 | +9 | +6 | +9 | +3 | +9 | +6 | +9 | 0 |

3) This embodiment describes an example of how to perform the geometry inter prediction with two reference frames when using octree geometry coding.

In this example, the geometry information is represented by an octree structure and the occupancy code of each node. As shown in FIG. 6, a hierarchical reference relationship is applied. For each frame, there are two reference frames which are used for geometry inter prediction.

At the encoder, the same octree division is performed on the current frame and the reference frames. Thus, the octree structures are the same for the current frame and the reference frames. A FIFO queue is used to store the nodes that need to be processed.

A bool flag predicted_forward is used for each node to indicate the source of the reference occupancy code:
a. If the reference occupancy code is the occupancy code of the node in the reference frame with an earlier time stamp, predicted_forward is set to 1.
b. If the reference occupancy code is the occupancy code of the node in the reference frame with a later time stamp, predicted_forward is set to 0.

A parameter mismatched_count_parent_node is used to indicate the number of mismatched bits between the occupancy code of the parent node and the reference occupancy code for parent node. Firstly, the root node of the octree of the current node is generated and pushed into the queue. The predicted_forward value of the root node is set to 1. The mismatched_count_parent_node value of the root node is set to 0.

Secondly, Perform the following process until the queue is empty:
a. Get the node at the header of the queue and its corresponding forward reference node and backward reference node. The forward reference node and the backward reference node are the nodes which share the same location in the octree structure as the current node in two reference frames. The first reference node is in the reference frame with an earlier time stamp, and the other reference node is in the reference frame with a later time stamp.
b. Calculate the occupancy codes for the current node, the forward reference node and the backward reference node as OC_{current}, OC_{forward}, OC_{backward}.
c. Count the numbers of mismatched bits between the current OC_{current} and OC_{forward} as mismatched_count_forward. Count the numbers of mismatched bits between the current OC_{current} and OC_{backward} as mismatched_count_backward.
d. If the predicted_forward of current node is 1, the reference occupancy code, OC_{reference} is set to OC_{forward}; Otherwise, OC_{reference} is set to OC_{backward}.
c. If the mismatched_count_parent_node is larger than 4, the OC_{reference} is set to all zero.
f. Use OC_{reference} and the intra prediction results as the part of the contexts to perform the predictive coding for OC_{current}.
g. If the current node can be divided into 8 child nodes, for each bit in OC_{current} and it correspond child node:
   i. If there is no point in the child node, skip it. Otherwise, move to next step.
   ii. Get the corresponding bits in OC_{forward} and OC_{backward}, as bit_0 and bit_1 respectively.
   iii. If bit_0=1 and bit_1=1, the predicted_forward value of the child node is set to 0 and the mismatched_count_parent_node value of the child node is set to mismatched_count_backward.
   iv. If bit_0=1 and bit_1=0, the predicted_forward value of the child node is set to 1 and the mismatched_count_parent_node value of the child node is set to mismatched_count_forward.
   v. If bit_0=0 and bit_1=0 or bit_0=1 and bit_1=1:
      (1) If mismatched_count_backward<mismatched_count_forward, the predicted_forward value of the child node is set to 0 and the mismatched_count_parent_node value of the child node is set to mismatched_count_backward.
      (2) If mismatched_count_backward>mismatched_count_forward, the predicted_forward value of the child node is set to 1 and the mismatched_count_parent_node value of the child node is set to mismatched_count_forward.
      (3) If mismatched_count_backward=mismatched_count_forward, the predicted_forward value of the child node is set to the predicted_forward value of the current node and the mismatched_count_parent_node value of the child node is set to mismatched_count_forward.
   vi. Push the child node into the queue.
h. Pop the current node out of the queue.

At the decoder, the same process is performed on the current frame and the reference frames. Thus, the reference occupancy code can be derived for each node. The occupancy code can be decoded based on the reference occupancy code.
4) This embodiment describes an example of how to perform the geometry inter prediction with two reference frames when using octree geometry coding.

In this example, the geometry information is represented by an octree structure and the occupancy code of each node. As shown in FIG. 6, a hierarchical reference relationship is applied. For each frame, there are two reference frames which are used for geometry inter prediction.

At the encoder, the same octree division is performed on the current frame and the reference frames. Thus, the octree structures are the same for the current frame and the reference frames. A FIFO queue is used to store the nodes that need to be processed.

A bool flag predicted_forward is used for each node to indicate the source of the reference occupancy code:
c. If the reference occupancy code is the occupancy code of the node in the reference frame with an earlier time stamp, predicted_forward is set to 1.
d. If the reference occupancy code is the occupancy code of the node in the reference frame with a later time stamp, predicted_forward is set to 0.

A parameter mismatched_count_parent_node is used to indicate the number of mismatched bits between the occupancy code of the parent node and the reference occupancy code for parent node. Firstly, the root node of the octree of the current node is generated and pushed into the queue. The predicted_forward value of the root node is set to 1. The mismatched_count_parent_node value of the root node is set to 0.

Secondly, Perform the following process until the queue is empty:
i. Get the node at the header of the queue and its corresponding forward reference node and backward reference node. The forward reference node and the backward reference node are the nodes which share the same location in the octree structure as the current node in two reference frames. The first reference node is in the reference frame with an earlier time stamp, and the other reference node is in the reference frame with a later time stamp.
j. Calculate the occupancy codes for the current node, the forward reference node and the backward reference node as OC_{current}, OC_{forward}, OC_{backward}.
k. Count the numbers of mismatched bits between the current OC_{current} and OC_{forward} as mismatched_count_forward. Count the numbers of mismatched bits between the current OC_{current} and OC_{backward} as mismatched_count_backward.
l. If the predicted_forward of current node is 1, the reference occupancy code, OC_{reference} is set to OC_{forward}; Otherwise, OC_{reference} is set to OC_{backward}.
m. If the mismatched_count_parent_node is larger than 4, the OC_{reference} is set to all zero.
n. Use OC_{reference} and the intra prediction results as the part of the contexts to perform the predictive coding for OC_{current}.
o. If the current node can be divided into 8 child nodes, for each bit in OC_{current} and it correspond child node:
   i. If there is no point in the child node, skip it. Otherwise, move to next step.
   ii. Get the corresponding bits in OC_{forward} and OC_{backward}, as bit_0 and bit_1 respectively.
   iii. If bit_0=0 and bit_1=1, the predicted_forward value of the child node is set to 0 and the mismatched_count_parent_node value of the child node is set to mismatched_count_backward.
   iv. If bit_0=1 and bit_1=0, the predicted_forward value of the child node is set to 1 and the mismatched_count_parent_node value of the child node is set to mismatched_count_forward.
   v. If bit_0=0 and bit_1=0 or bit_0=1 and bit_1=1:
      (1) If mismatched_count_backward<mismatched_count_forward, the predicted_forward value of the child node is set to 0 and the mismatched_count_parent_node value of the child node is set to mismatched_count_backward.
      (2) If mismatched_count_backward>mismatched_count_forward, the predicted_forward value of the child node is set to 1 and the mismatched_count_parent_node value of the child node is set to mismatched_count_forward.
      (3) If mismatched_count_backward=mismatched_count_forward, the predicted_forward value of the child node is set to the predicted_forward value of the current node and the mismatched_count_parent_node value of the child node is set to mismatched_count_forward.
   vi. Push the child node into the queue.
p. Pop the current node out of the queue.

At the decoder, the same process is performed on the current frame and the reference frames. Thus, the reference occupancy code can be derived for each node. The occupancy code can be decoded based on the reference occupancy code.
5) This embodiment describes an example of how to perform the attribute inter prediction with two reference frames.

In this example, the attribute information is represented by the reflection value of each point. As shown in FIG. 6, a hierarchical reference relationship is applied. For each frame, there are two reference frames which are used for attribute inter prediction.

At the encoder, 3 reference points, {point 0, point 1, point 2}, will be selected from the current frame and the reference frames. The predicted attribute value will be calculated based on the attribute values of the reference points. Then the residual between the predicted attribute value and the current attribute value will be calculated and signaled to the decoder.

For each point, an array neighbors is used to record the selected reference points with weight value. The weight value of each reference point is the distance between the reference point and the current point.

Firstly, the points in the current frame and the reference frames are reordered by motion code order.

Secondly, for each point, the encoder will search 3 reference points which are nearest to the current point. The search results and their weight values will be stored in neighbors:
a. The reference point searching is performed on the current frame:
   i. Scan the coded points within the same motion code level.
   ii. Scan the coded points within a search range. The search range is defined by a parameter.
b. The reference point searching is performed on the reference frames:
   iii. Scan the coded points within the same motion code level.
   iv. Scan the coded points within a search range. The search range is defined by a parameter.

Thirdly, the weight values of the reference points will be recomputed. The reference point from the current frame should have higher weight value.

Fourthly, the predicted attribute value will be selected from a candidate list:
a. The weighted average of the attribute values of the reference points.
b. Attribute value of the reference point 0.
c. Attribute value of the reference point 1.
d. Attribute value of the reference point 2.

For each candidate value, a coding score will be calculated based on the compression bits and prediction residual. Then the encoder will select the candidate value with the highest coding score. The indication referring to the selected candidate will be signaled to the decoder.

Finally, the residual between the attribute value and the predicted attribute value will be calculated and signaled to the decoder.

At the decoder, the reference points will be searched for each point by the same method as the encoding process. The candidate list will be calculated in the same way and the indication will be decoded for each point to get the predicted attribute value. Based on that, the prediction residual will be decoded and the real attribute value will be generated.
6) This embodiment describes an example of how to perform the inter prediction for both geometry coding and attribute coding with two reference frames.

A hierarchical GOF structure is proposed to perform the inter prediction for geometry coding and attribute coding.

In the hierarchical GOF structure, the first frame in each GOF is an I-frame. The other frames in the GOF are B-frames, which means that the frame will use two reference frames from the forward and backward directions.

As shown in FIG. 7, the frame “0”˜“7” are the frames in one GOF and the frame “8” is the first frame of the next GOF.

For frame “0”˜“8”, the reference frames are shown in Table 5.

TABLE 5
Reference frames for each frame in one GOF

| Frame time stamp | 0 | 1 | 2 | 3 | 4 | 5 | 6 | 7 | 8 |
|---|---|---|---|---|---|---|---|---|---|
| Reference frame | None | 0, 2 | 0, 4 | 2, 4 | 0, 8 | 4, 6 | 4, 8 | 6, 8 | None |
| time stamp | | | | | | | | | |

The encoding and decoding order for frame “0”˜“8” are {0, 8, 4, 2, 1, 3, 6, 5, 7}.

For geometry coding, the same octree division is performed on the current frame and the two reference frames.

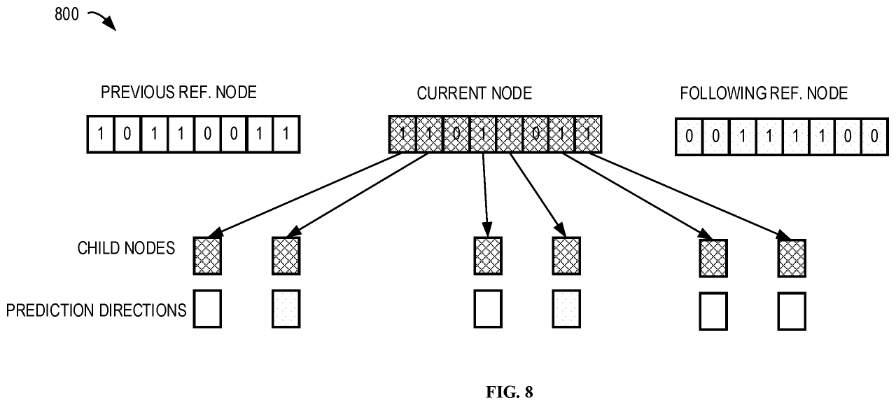

For each node in octree, the occupancy codes of the current node and the reference nodes are calculated. As shown in FIG. 8, the prediction direction of the child nodes of the current node are derived based on the occupancy codes of the current node and the reference nodes.

For each child node of the current node, the corresponding bit values in the occupancy codes of the reference nodes are denoted as bit_pre and bit_follow:

If bit_pre=1 and bit_follow=0, the prediction direction of the child node is set to using the previous reference (forward) node to perform inter prediction.

If bit_pre=0 and bit_follow=1, the prediction direction of the child node is set to using the following reference (backward) node to perform inter prediction.

If bit_pre=bit_follow, the numbers of the mismatched bits between the occupancy code of current node and the occupancy codes of the reference nodes are calculated.

If the numbers of the mismatched bits are different, the prediction direction of the child node is set to the prediction direction with less mismatched number. Otherwise, the prediction direction of the child node is set to the prediction direction of the current node.

When coding the attribute, three reference points, {point 0, point 1, point 2}, are selected from the current frame and the two reference frames. The predicted attribute value will be calculated based on the attribute values of the reference points, which is similar with the Inter-EM.

Besides, a hierarchical QP structure is applied to perform the attribute coding. There is a QP_{shift} value for each frame based on the reference relationship. The QP_{shift} value for reference frame should be lower than that of the current frame.

For each frame, the real attribute QP value is set to:

$${QP}_{original} + {QP}_{shift}$$

The quantization process is performed based on the real attribute QP value.

More details of the embodiments of the present disclosure will be described below which are related to coding and encapsulation of coding parameters in point cloud coding.

As discussed above, in one point cloud frame, there are many data points to describe the 3D objects or scenes. For each data point, there may be corresponding geometry information and attribute information. The geometry information is used to record the spatial location of the data point. The attribute information is used to record more details of the data point, such as texture, normal vector and reflection.

Either the attribute information or the geometry information can be used for performing inter prediction for each point in a frame. However, both the prediction accuracy and the coding efficiency of conventional inter prediction need to be further improved.

To solve the above problems and some other problems not mentioned, methods as summarized below are disclosed. The embodiments of the present disclosure should be considered as examples to explain the general concepts and should not be interpreted in a narrow way. Furthermore, these embodiments can be applied individually or combined in any manner.

As used herein, the term “PC sample” may refer to the unit that performs prediction coding in the point cloud sequence coding, such as frame/picture/slice/tile/subpicture/node/point/other units that contains one or more nodes or points.

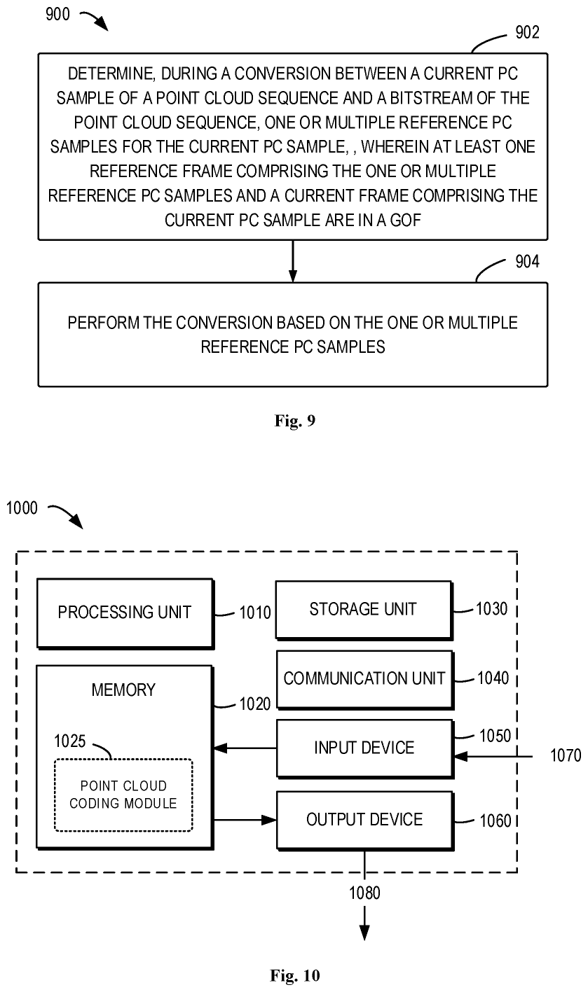

FIG. 9 illustrates a flowchart of a method 900 for point cloud coding in accordance with some embodiments of the present disclosure. As shown in FIG. 9, the method 900 starts at 902, where during a conversion between a current PC sample of a point cloud sequence and a bitstream of the point cloud sequence, one or multiple reference PC samples are determined for the current PC sample.

The current PC sample may comprise a frame, one or more points or other units in a frame or a picture. In some embodiments, current PC sample may be comprised in a current frame of the point cloud sequence. The multiple reference PC samples may be from a plurality of reference frames or only one reference frame of the point cloud sequence. In other words, the one or multiple reference PC samples may be comprised in at least one reference frame.

To perform point cloud compression, frames in the point cloud sequence may be divided into one or more groups of frames (GOFs). According to embodiments of the present disclosure, the at least one reference frame and the current frame are in the same GOF.

According to embodiments of the present disclosure, there are no limit on time stamp(s) of the one or multiple reference PC samples and the current PC sample. That is, the time stamp of any of the one or multiple reference PC samples may be earlier or later than that of the current PC sample. For example, there may be a plurality of reference PC sample for the current PC sample, and these reference PC sample may have earlier or later time stamps than the current PC sample. Alternatively, in some embodiments, if the current PC sample only has one reference PC sample, the reference PC sample may have a time stamp later than that of the current PC sample. As a further alternative, if the current PC sample only has one reference PC sample, the time stamp of the reference PC sample may be earlier than that of the current PC sample, but the reference PC sample is not a PC sample immediately preceding the current PC sample in terms of the time stamp.

At 904, the conversion is performed based on the one or multiple reference PC samples.

According to the method 900, a hierarchical GOF structure is proposed to perform the inter prediction for geometry coding and attribute coding. One or multiple reference PC samples in the same GOF as the current PC sample may be used for the current PC sample, which improves prediction accuracy and increases the coding efficiency. Moreover, the one or more reference PC samples may have later or earlier time stamps than the current frame, which also causes the coding performance to be improved.

Implementations of the present disclosure can be described in view of the following clauses, the features of which can be combined in any reasonable manner.

In some embodiments, frames of the point cloud sequence may be divided into one or more GOFs to perform point cloud compression. There may be various ways for dividing the frames into the one or more GOFs. For example, a plurality of consecutive frames of the point cloud sequence in time stamp order may be clustered as one GOF. The GOFs may have the same or different size. For instance, the number of the plurality of consecutive frames equals to a size of the GOF.

Alternatively, in some embodiments, each frame of the point cloud sequence belongs to one GOF.

In some embodiments, the first frame of a GOF in decoding order may be an I-frame. In some embodiments, there is only intra prediction for the I-frame.

In some embodiments, the first frame of a GOF in decoding order is not an I-frame. In some embodiments, the first frame of a GOF in decoding order is a P-frame.

In some embodiments, the first frame of a GOF in decoding order may be a P-frame or a B frame with all of the at least one reference frame ahead of the current frame in the time stamp order.

In some embodiments, whether to code the first frame of a GOF in decoding order with I-frame may depend on an intra period or a random access period.

In some embodiments, the size of a GOF may be equal to the intra period or the random access period.

In some embodiments, the size of a GOF may be smaller than the intra period or the random access period.

In some embodiments, an indication of the size of a GOF and/or coding structure within a GOF may be indicated in the bitstream. In this way, the indication can be signalled to the decoder of the bitstream.

In some embodiments, at 904, the conversion may be performed by performing inter prediction for the current PC sample by using the one or multiple reference PC samples.

In some embodiments, the multiple reference PC samples may be from different frames or slices. Alternatively, the multiple reference PC samples may be from the same frame or slice.

In some embodiments, a reference PC sample in the one or multiple reference PC samples may be from a frame or slice comprising the current PC sample.

In some embodiments, an indication about whether to use the multiple reference PC samples is indicated in the bitstream.

In some embodiments, the reference information of the current PC sample may be derived at a decoder of the bitstream. Alternatively or in addition, the reference information of the current PC sample may be indicated in the bitstream.

The reference information may comprise information related to the reference PC sample(s), for example, where the reference PC samples are from and/or which reference PC samples are to be used.

In some embodiments, the reference information may comprise a reference direction. whether a reference direction is indicated in the bitstream may depend on reference picture list information. Alternatively or in addition, the reference information may comprise an indication of a reference frame where the one or multiple reference PC samples are from, an indication of the number of the one or multiple reference PC samples, a reference relationship indication referring to at least one of the one or multiple reference PC samples, at least one of the one or multiple reference PC samples, and/or the like.

The reference direction may comprise various information. For example, the reference direction comprises a uni-prediction from a reference frame in a first reference list, a uni-prediction from a reference frame in a second reference list different from the first reference list, a bi-prediction from a first reference frame in the first reference list and a second reference frame in the second reference list, and/or the like.

In some embodiments, relative positions of reference frames in a reference list may be fixed for the current frame within one GOF.

In some embodiments, the previously coded N frames in displayer order may be utilized as the reference frames, N being an integer. For example, N equals to 2. In some embodiments, N may be indicated in the bitstream.

In some embodiments, the N frames may be consecutively previously coded frames right before the current frame.

In some embodiments, the relative positions of the reference frames in reference lists may be adaptive for the current frame in a GOF. For example, the relative positions may be derived based on a size of the GOF (also referred to as “GOF size” in the present disclosure).

In some embodiments, the indication of the reference frame is indicated as a reference list index and a reference frame index in the reference list. The reference list index may be the first reference list or the second reference list. Alternatively, the indication of the reference frame is indicated by a reference direction and a reference frame index for the reference direction.

In some embodiments, if there is only one reference list, the reference list index is not indicated in the bitstream.

In some embodiments, if there is only one reference frame in the reference list, the reference frame index is not indicated in the bitstream.

In some embodiments, whether a reference relationship indication referring to at least one of the one or multiple reference PC samples is indicated in the bitstream depends on whether to use other samples rather than the previous one sample as the reference PC samples.

In some embodiments, the reference relationship indication is represented by an index indicating an associated sample to be used as one of the reference PC samples.

In some embodiments, the reference relationship indication may be coded with a various coding approaches, such as, fixed-length coding, unary coding, truncated unary coding, or the like. In addition or alternatively, the reference relationship indication may be coded in a predictive way.

In some embodiments, the one or multiple reference PC samples may comprise a first reference PC sample in a reference frame with a later time stamp than the current frame comprising the current PC sample.

In some embodiments, there may be time stamp information for each frame in the point cloud sequence.

In some embodiments, a time stamp order of frames in the point cloud sequence may be the same as their displaying order. Alternatively, or in addition, the time stamp order of frames in the point cloud sequence may be the same as their rendering order.

In some embodiments, a time stamp for each PC sample may be equal to a time stamp of a frame comprising the PC sample.

In some embodiments, the one or multiple reference PC samples may comprise a second reference PC sample with an earlier time stamp than the current frame comprising the current PC sample.

In some embodiments, the one or multiple reference PC samples may comprise a third reference PC sample with the same time stamp as the current frame comprising the current PC sample.

In some embodiments, an indication indicating whether a sample with a later time stamp than the current frame is allowed to be used as a reference PC sample may be indicated in the bitstream. In this way, this indication may be signalled to the decoder.

In some embodiments, there is a low-delay mode for point cloud compres-sion. With the low-delay mode, a time stamp order of frames in the point cloud sequence and a decoding order of frames in the point cloud sequence may be the same.

In some embodiments, an indication of whether to use low-delay mode may be indicated in the bitstream.

In some embodiments, the multiple reference frames may be used for the low-delay mode.

In some embodiments, a sample in a frame with an earlier time stamp or the same time stamp may be used as the reference PC sample in low delay mode. Alternatively, or in addition, In some embodiments, a sample with an earlier time stamp than the cur-rent PC sample may be used as a reference PC sample for the current PC sample in low delay mode.

In some embodiments, a sample with the same time stamp as the current PC sample may be used as a reference PC sample for the current PC sample in low delay mode.

According to some embodiments of the present disclosure, the current PC sample and the one or multiple reference PC samples may be coded in different orders and/or with different coding accuracies. In this way, in the case of limited transmission resources, the reference PC samples can be assigned a lower QP value to ensure that they can be transmitted more accurately. As such, there is no need to apply the same coding accuracy for all frames. Accordingly, the coding performance can be improved.

In some embodiments, PC samples in the point cloud sequence may have different coding priorities. In this case, the method 700 may further comprise: applying hierarchical coding accuracies to the PC samples based on the coding priorities of the PC samples. The coding priorities of the PC samples may be configured in different ways. For example, coding priorities of the one or multiple reference PC samples may be higher than the current PC sample.

In some embodiments, coding accuracy of a first PC sample in the point cloud sequence with a higher coding priority may be higher than a second PC sample in the point cloud sequence with a lower coding priority.

In some embodiments, the coding accuracies of PC samples in the point cloud sequence may be controlled by a QP value or a quantization step in the point cloud sequence coding. The QP value or the quantization step for a reference PC sample in the one or more multiple reference PC samples may be smaller than that for the current PC sample.

In some embodiments, a delta value of the QP value or the quantization step for a reference PC sample is fixed, or a delta value of the QP value or the quantization step for the current PC sample is fixed.

In some embodiments, a delta value of the QP value or the quantization step for a reference PC sample may be derived at a decoder of the bitstream. Alternatively, or in addition, a delta value of the QP value or the quantization step for the current PC sample may be derived at a decoder of the bitstream.

In some embodiments, the delta value may be derived based on a variety of factors, for example, a size of a GOF, an intra period or a random access period, indicators of lossless coding mode, indicators of low delay coding mode, and/or the like.

In some embodiments, a delta value of the QP value or the quantization step for a reference PC sample is indicated in the bitstream. Alternatively, or in addition, a delta value of the QP value or the quantization step for the current PC sample may be indicated in the bitstream.

In some embodiments, a delta value of the QP value or the quantization step for a reference PC sample may be indicated in the bitstream. Alternatively, or in addition, a delta value of the QP value or the quantization step for the current PC sample may be indicated in the bitstream.

In some embodiments, an indication indicating whether hierarchical QP values and/or QP values or quantization steps are to be used may be indicated in the bitstream. As such, this indication can be signalled to the decoder of the bitstream.

In some embodiments, a QP value for each PC sample in the point cloud sequence may be derived at a decoder of the bitstream. Alternatively or in addition, a QP value for a frame, a block, a cube, a tile, or a slice the point cloud sequence is derived at a decoder of the bitstream.

In some embodiments, a PC sample may be one of the following: a frame, a picture, a slice, a tile, a subpicture, a node, a point, or a unit containing one or more nodes or points.

In some embodiments, the conversion includes encoding the current PC sample into the bitstream.

In some embodiments, the conversion includes decoding the current PC sample from the bitstream.

It is to be understood that the above-mentioned examples are only for the purpose of illustration, without suggesting any limitations. Scope of the present disclosure may not be limited in this regard.

According to further embodiments of the present disclosure, a bitstream of a point cloud sequence may be stored in a non-transitory computer-readable recording medium. The bitstream of the point cloud sequence can be generated by a method performed by a point cloud processing apparatus. According to the method, one or multiple reference PC samples are determined for a current PC sample of the point cloud sequence. At least one reference frame comprises the one or multiple reference PC samples and a current frame comprising the current PC sample are in a GOF. A bitstream of the current frame may be generated based on the one or multiple reference PC samples.

According to still further embodiments of the present disclosure, a method for storing a bitstream of a point cloud sequence is proposed. In the method, one or multiple reference PC samples are determined for one or multiple reference PC samples are determined for a current PC sample of the point cloud sequence. At least one reference frame comprises the one or multiple reference PC samples and a current frame comprising the current PC sample are in a GOF. A bitstream of the current frame may be generated based on the one or multiple reference PC samples. The bitstream may be stored in a non-transitory computer-readable recording medium.

Implementations of the present disclosure can be described in view of the following clauses, the features of which can be combined in any reasonable manner.
Clause 1. A method for point cloud coding, comprising: determining, during a conversion between a current point cloud (PC) sample of a point cloud sequence and a bitstream of the point cloud sequence, one or multiple reference PC samples for the current PC sample, wherein at least one reference frame comprising the one or multiple reference PC samples and a current frame comprising the current PC sample are in a group of frames (GOF); and performing the conversion based on the one or multiple reference PC samples.
Clause 2. The method of clause 1, wherein frames of the point cloud sequence are divided into one or more groups of frames (GOFs) to perform point cloud compression.
Clause 3. The method of clause 2, wherein a plurality of consecutive frames of the point cloud sequence in time stamp order are clustered as one GOF.
Clause 4. The method of clause 2 or 3, wherein each frame of the point cloud sequence belongs to one GOF.
Clause 5. The method of clause 3, wherein the number of the plurality of consecutive frames equals to a size of the GOF.
Clause 6. The method of clause 2, wherein the first frame of a GOF in decoding order is an I-frame.
Clause 7. The method of clause 6, wherein there is only intra prediction for the I-frame.
Clause 8. The method of clause 2, wherein the first frame of a GOF in decoding order is not an I-frame.
Clause 9. The method of clause 8, wherein the first frame of a GOF in decoding order is a P-frame.
Clause 10. The method of clause 8, wherein the first frame of a GOF in decoding order is a P-frame or a B frame with all of the at least one reference frame ahead of the current frame in the time stamp order.
Clause 11. The method of clause 2, wherein whether to code the first frame of a GOF in decoding order with I-frame depends on an intra period or a random access period.
Clause 12. The method of clause 11, wherein the size of a GOF is equal to the intra period or the random access period.
Clause 13. The method of clause 11, wherein the size of a GOF is smaller than the intra period or the random access period.
Clause 14. The method of clause 11, wherein an indication of the size of a GOF and/or coding structure within a GOF is indicated in the bitstream.
Clause 15. The method of any of clause 1-14, wherein performing the conversion based on the one or more reference PC samples comprises: performing inter prediction for the current PC sample by using the one or multiple reference PC samples.
Clause 16. The method of any clauses 1 to 15, wherein the multiple reference PC samples are from different frames or slices, or wherein the multiple reference PC samples are from the same frame or slice.
Clause 17. The method of any clauses 1 to 15, wherein a reference PC sample in the one or multiple reference PC samples is from a frame or slice comprising the current PC sample.
Clause 18. The method of any clauses 1 to 17, wherein an indication about whether to use the multiple reference PC samples is indicated in the bitstream.
Clause 19. The method of any of clauses 1 to 18, wherein reference information of the current PC sample is derived at a decoder of the bitstream, or wherein reference information of the current PC sample is indicated in the bitstream.
Clause 20. The method of clause 19, wherein the reference information comprises where the reference PC samples are from and/or which reference PC samples are to be used.
Clause 21. The method of clause 20, wherein the reference information comprises at least one of the following: a reference direction, an indication of a reference frame where the one or multiple reference PC samples are from, an indication of the number of the one or multiple reference PC samples, a reference relationship indication referring to at least one of the one or multiple reference PC samples, or at least one of the one or multiple reference PC samples.
Clause 22. The method of clause 19, wherein whether a reference direction is indicated in the bitstream depends on reference picture list information.
Clause 23. The method of clause 21 or 22, wherein the reference direction comprises at least one of the following: a uni-prediction from a reference frame in a first reference list, a uni-prediction from a reference frame in a second reference list different from the first reference list, or a bi-prediction from a first reference frame in the first reference list and a second reference frame in the second reference list.
Clause 24. The method of clause 23, wherein relative positions of reference frames in a reference list is fixed for the current frame within one group of frames (GOF).
Clause 25. The method of clause 23, wherein the previously coded N frames in displayer order are utilized as the reference frames, N being an integer.
Clause 26. The method of clause 25, wherein N is indicated in the bitstream.
Clause 27. The method of clause 25, wherein the N frames are consecutively previously coded frames right before the current frame.
Clause 28. The method of clause 23, wherein the relative positions of the reference frames in reference lists are adaptive for the current frame in a GOF.
Clause 29. The method of clause 28, wherein the relative positions are derived based on a size of the GOF.
Clause 30. The method of clause 23, wherein the indication of the reference frame is indicated as a reference list index and a reference frame index in the reference list, the reference list index being the first reference list or the second reference list, or the indication of the reference frame is indicated by a reference direction and a reference frame index for the reference direction.
Clause 31. The method of clause 30, wherein if there is only one reference list, the reference list index is not indicated in the bitstream.
Clause 32. The method of clause 30 or 31, wherein if there is only one reference frame in the reference list, the reference frame index is not indicated in the bitstream.
Clause 33. The method of clause 19, wherein whether a reference relationship indication referring to at least one of the one or multiple reference PC samples is indicated in the bitstream depends on whether to use other samples rather than the previous one sample as the reference PC samples.
Clause 34. The method of clause 21 or 33, wherein the reference relationship indication is represented by an index indicating an associated sample to be used as one of the reference PC samples.
Clause 35. The method of any of clauses 21, 33 or 34, wherein the reference relationship indication is coded with one of the following: fixed-length coding, unary coding, or truncated unary coding.
Clause 36. The method of any of clauses 21 and 33 to 35, wherein the reference relationship indication is coded in a predictive way.
Clause 37. The method of any of clauses 1 to 36, wherein the one or multiple reference PC samples comprise a first reference PC sample in a reference frame with a later time stamp than the current frame comprising the current PC sample.
Clause 38. The method of clause 37, wherein there is time stamp information for each frame in the point cloud sequence.
Clause 39. The method of clause 37, wherein a time stamp order of frames in the point cloud sequence is the same as their displaying order.
Clause 40. The method of clause 37, wherein a time stamp order of frames in the point cloud sequence is the same as their rendering order.
Clause 41. The method of clause 37, wherein a time stamp for each sample is equal to a time stamp of a frame comprising the sample.
Clause 42. The method of any of clauses 1 to 41, wherein the one or multiple reference PC samples comprise a second reference PC sample with an earlier time stamp than the current frame comprising the current PC sample.
Clause 43. The method of any of clauses 1 to 42, wherein the one or multiple reference PC samples comprise a third reference PC sample with the same time stamp as the current frame comprising the current PC sample.
Clause 44. The method of any of clauses 1 to 43, wherein an indication indicating whether a sample with a later time stamp than the current frame is allowed to be used as a reference PC sample is indicated in the bitstream.
Clause 45. The method of clause 1, wherein there is a low-delay mode for point cloud compression.
Clause 46. The method of clause 45, wherein with the low-delay mode, a time stamp order of frames in the point cloud sequence and a decoding order of frames in the point cloud sequence are the same.
Clause 47. The method of clause 45, wherein an indication of whether to use low-delay mode is indicated in the bitstream.
Clause 48. The method of clause 45, wherein the multiple reference frames are used for the low-delay mode.
Clause 49. The method of clause 1, wherein a sample in a frame with an earlier time stamp or the same time stamp is used as the reference PC sample in low delay mode.
Clause 50. The method of clause 49, wherein a sample with an earlier time stamp than the current PC sample is used as a reference PC sample for the current PC sample in low delay mode.
Clause 51. The method of clause 49, wherein a sample with the same time stamp as the current PC sample is used as a reference PC sample for the current PC sample in low delay mode.
Clause 52. The method of clause 1, wherein the current PC sample and the one or multiple reference PC samples are coded in different orders and/or with different coding accuracies.
Clause 53. The method of clause 52, wherein PC samples in the point cloud sequence have different coding priorities.
Clause 54. The method of clause 53, further comprising: applying hierarchical coding accuracies to the PC samples based on the coding priorities of the PC samples.
Clause 55. The method of clause 53, wherein coding priorities of the one or multiple reference PC samples are higher than the current PC sample.
Clause 56. The method of clause 53, wherein coding accuracy of a first PC sample in the point cloud sequence with a higher coding priority is higher than a second PC sample in the point cloud sequence with a lower coding priority.
Clause 57. The method of clause 52, wherein coding accuracies of PC samples in the point cloud sequence are controlled by a Quantization Parameter (QP) value or a quantization step in the point cloud sequence coding.
Clause 58. The method of clause 57, wherein the QP value or the quantization step for a reference PC sample in the one or more multiple reference PC samples is smaller than that for the current PC sample.
Clause 59. The method of clause 57, wherein a delta value of the QP value or the quantization step for a reference PC sample is fixed, or wherein a delta value of the QP value or the quantization step for the current PC sample is fixed.
Clause 60. The method of clause 57, wherein a delta value of the QP value or the quantization step for a reference PC sample is derived at a decoder of the bitstream, or wherein a delta value of the QP value or the quantization step for the current PC sample is derived at a decoder of the bitstream.
Clause 61. The method of clause 60, wherein the delta value is derived based on at least one of the following: a size of a GOF, an intra period or a random access period, indicators of lossless coding mode, or indicators of low delay coding mode.
Clause 62. The method of clause 57, wherein a delta value of the QP value or the quantization step for a reference PC sample is indicated in the bitstream, or wherein a delta value of the QP value or the quantization step for the current PC sample is indicated in the bitstream.
Clause 63. The method of clause 57, wherein a delta value of the QP value or the quantization step for a reference PC sample is indicated in the bitstream, or wherein a delta value of the QP value or the quantization step for the current PC sample is indicated in the bitstream.
Clause 64. The method of any of clauses 52 to 63, wherein an indication indicating whether hierarchical QP values and/or QP values or quantization steps are to be used is indicated in the bitstream.
Clause 65. The method of any of clauses 52 to 64, wherein a QP value for each PC sample in the point cloud sequence is derived at a decoder of the bitstream.
Clause 66. The method of any of clauses 1 to 65, wherein a PC sample is one of the following: a frame, a picture, a slice, a tile, a subpicture, a node, a point, or a unit containing one or more nodes or points.
Clause 67. The method of any of clauses 1 to 66, wherein the conversion includes encoding the current PC sample into the bitstream.
Clause 68. The method of any of clauses 1 to 66, wherein the conversion includes decoding the current PC sample from the bitstream.
Clause 69. An apparatus for processing point cloud data comprising a processor and a non-transitory memory with instructions thereon, wherein the instructions upon execution by the processor, cause the processor to perform a method in accordance with any of clauses 1-68.
Clause 70. A non-transitory computer-readable storage medium storing instructions that cause a processor to perform a method in accordance with any of clauses 1-68.
Clause 71. A non-transitory computer-readable recording medium storing a bitstream of a point cloud sequence which is generated by a method performed by a point cloud processing apparatus,
wherein the method comprises: determining one or multiple reference point cloud (PC) samples for a current PC sample of the point cloud sequence, wherein at least one reference frame comprising the one or multiple reference PC samples and a current frame comprising the current PC sample are in a group of frames (GOF); and generating the bitstream based on the one or multiple reference PC samples.
Clause 72. A method for storing a bitstream of a point cloud sequence, comprising: determining one or multiple reference point cloud (PC) samples for a current PC sample of the point cloud sequence, wherein at least one reference frame comprising the one or multiple reference PC samples and a current frame comprising the current PC sample are in a group of frames (GOF); and generating the bitstream based on the one or multiple reference PC samples; and storing the bitstream in a non-transitory computer-readable recording medium.

### Example Device

FIG. 10 illustrates a block diagram of a computing device 1000 in which various embodiments of the present disclosure can be implemented. The computing device 1000 may be implemented as or included in the source device 110 (or the point cloud encoder 114 or 200) or the destination device 120 (or the point cloud decoder 124 or 300).

It would be appreciated that the computing device 1000 shown in FIG. 10 is merely for purpose of illustration, without suggesting any limitation to the functions and scopes of the embodiments of the present disclosure in any manner.

As shown in FIG. 10, the computing device 1000 includes a general-purpose computing device 1000. The computing device 1000 may at least comprise one or more processors or processing units 1010, a memory 1020, a storage unit 1030, one or more communication units 1040, one or more input devices 1050, and one or more output devices 1060.

In some embodiments, the computing device 1000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1000 can support any type of interface to a user (such as “wearable” circuitry and the like).

The processing unit 1010 may be a physical or virtual processor and can implement various processes based on programs stored in the memory 1020. In a multi-processor system, multiple processing units execute computer executable instructions in parallel so as to improve the parallel processing capability of the computing device 1000. The processing unit 1010 may also be referred to as a central processing unit (CPU), a microprocessor, a controller or a microcontroller.

The computing device 1000 typically includes various computer storage medium. Such medium can be any medium accessible by the computing device 1000, including, but not limited to, volatile and non-volatile medium, or detachable and non-detachable medium. The memory 1020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1030 may be any detachable or non-detachable medium and may include a machine-readable medium such as a memory, flash memory drive, magnetic disk or another other media, which can be used for storing information and/or data and can be accessed in the computing device 1000.

The computing device 1000 may further include additional detachable/non-detachable, volatile/non-volatile memory medium. Although not shown in FIG. 10, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1040 communicates with a further computing device via the communication medium. In addition, the functions of the components in the computing device 1000 can be implemented by a single computing cluster or multiple computing machines that can communicate via communication connections. Therefore, the computing device 1000 can operate in a networked environment using a logical connection with one or more other servers, networked personal computers (PCs) or further general network nodes.

The input device 1050 may be one or more of a variety of input devices, such as a mouse, keyboard, tracking ball, voice-input device, and the like. The output device 1060 may be one or more of a variety of output devices, such as a display, loudspeaker, printer, and the like. By means of the communication unit 1040, the computing device 1000 can further communicate with one or more external devices (not shown) such as the storage devices and display device, with one or more devices enabling the user to interact with the computing device 1000, or any devices (such as a network card, a modem and the like) enabling the computing device 1000 to communicate with one or more other computing devices, if required. Such communication can be performed via input/output (I/O) interfaces (not shown).

In some embodiments, instead of being integrated in a single device, some or all components of the computing device 1000 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1000 may be used to implement point cloud encoding/decoding in embodiments of the present disclosure. The memory 1020 may include one or more point cloud coding modules 1025 having one or more program instructions. These modules are accessible and executable by the processing unit 1010 to perform the functionalities of the various embodiments described herein.

In the example embodiments of performing point cloud data encoding, the input device 1050 may receive point cloud data as an input 1070 to be encoded. The point cloud data may be processed, for example, by the point cloud coding module 1025, to generate an encoded bitstream. The encoded bitstream may be provided via the output device 1060 as an output 1080.

In the example embodiments of performing point cloud data decoding, the input device 1050 may receive an encoded bitstream as the input 1070. The encoded bitstream may be processed, for example, by the point cloud coding module 1025, to generate decoded point cloud data. The decoded point cloud data may be provided via the output device 1060 as the output 1080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud coding, comprising:
determining, during a conversion between a current point cloud (PC) sample of a point cloud sequence and a bitstream of the point cloud sequence, one or multiple reference PC samples for the current PC sample, wherein at least one reference frame comprising the one or multiple reference PC samples and a current frame comprising the current PC sample are in a group of frames (GOF); and
performing the conversion based on the one or multiple reference PC samples.

2. The method of claim 1, wherein frames of the point cloud sequence are divided into one or more groups of frames (GOFs) to perform point cloud compression.

3. The method of claim 2, wherein a plurality of consecutive frames of the point cloud sequence in time stamp order are clustered as one GOF, or
wherein each frame of the point cloud sequence belongs to one GOF, or
wherein the number of the plurality of consecutive frames equals to a size of the GOF, or
wherein the first frame of a GOF in decoding order is an I-frame, or
wherein the first frame of a GOF in decoding order is an I-frame, and there is only intra prediction for the I-frame, or
wherein the first frame of a GOF in decoding order is not an I-frame, or
wherein the first frame of a GOF in decoding order is a P-frame, or
wherein the first frame of a GOF in decoding order is a P-frame or a B frame with all of the at least one reference frame ahead of the current frame in the time stamp order, or
wherein whether to code the first frame of a GOF in decoding order with I-frame depends on an intra period or a random access period.

4. The method of claim 3, wherein the size of a GOF is equal to the intra period or the random access period, or
wherein the size of a GOF is smaller than the intra period or the random access period, or
wherein an indication of the size of a GOF and/or coding structure within a GOF is indicated in the bitstream.

5. The method of claim 1, wherein performing the conversion based on the one or more reference PC samples comprises: performing inter prediction for the current PC sample by using the one or multiple reference PC samples, or
wherein the multiple reference PC samples are from different frames or slices, or
wherein the multiple reference PC samples are from the same frame or slice,
wherein a reference PC sample in the one or multiple reference PC samples is from a frame or slice comprising the current PC sample, or
wherein an indication about whether to use the multiple reference PC samples is indicated in the bitstream, or
wherein reference information of the current PC sample is derived at a decoder of the bitstream, or
wherein reference information of the current PC sample is indicated in the bitstream, or
wherein the reference information comprises where the reference PC samples are from and/or which reference PC samples are to be used, or
wherein the reference information comprises at least one of the following: a reference direction, an indication of a reference frame where the one or multiple reference PC samples are from, an indication of the number of the one or multiple reference PC samples, a reference relationship indication referring to at least one of the one or multiple reference PC samples, or at least one of the one or multiple reference PC samples, or
wherein whether a reference direction is indicated in the bitstream depends on reference picture list information.

6. The method of claim 5, wherein the reference direction comprises at least one of the following:
a uni-prediction from a reference frame in a first reference list,
a uni-prediction from a reference frame in a second reference list different from the first reference list, or
a bi-prediction from a first reference frame in the first reference list and a second reference frame in the second reference list.

7. The method of claim 6, wherein relative positions of reference frames in a reference list is fixed for the current frame within one group of frames (GOF), or
wherein the previously coded N frames in displayer order are utilized as the reference frames, N being an integer, or
wherein N is indicated in the bitstream, or
wherein the N frames are consecutively previously coded frames right before the current frame, or
wherein the relative positions of the reference frames in reference lists are adaptive for the current frame in a GOF, or
wherein the relative positions are derived based on a size of the GOF, or
wherein the indication of the reference frame is indicated as a reference list index and a reference frame index in the reference list, the reference list index being the first reference list or the second reference list, or
wherein the indication of the reference frame is indicated by a reference direction and a reference frame index for the reference direction, or
wherein if there is only one reference list, the reference list index is not indicated in the bitstream, or
wherein if there is only one reference frame in the reference list, the reference frame index is not indicated in the bitstream, or
wherein whether a reference relationship indication referring to at least one of the one or multiple reference PC samples is indicated in the bitstream depends on whether to use other samples rather than the previous one sample as the reference PC samples, or
wherein the reference relationship indication is represented by an index indicating an associated sample to be used as one of the reference PC samples, or
wherein the reference relationship indication is coded with one of the following: fixed-length coding, unary coding, or truncated unary coding, or
wherein the reference relationship indication is coded in a predictive way.

8. The method of claim 1, wherein the one or multiple reference PC samples comprise a first reference PC sample in a reference frame with a later time stamp than the current frame comprising the current PC sample.

9. The method of claim 8, wherein there is time stamp information for each frame in the point cloud sequence, or
wherein a time stamp order of frames in the point cloud sequence is the same as their displaying order, or
wherein a time stamp order of frames in the point cloud sequence is the same as their rendering order, or
wherein a time stamp for each sample is equal to a time stamp of a frame comprising the sample.

10. The method of claim 1, wherein the one or multiple reference PC samples comprise a second reference PC sample with an earlier time stamp than the current frame comprising the current PC sample, or
wherein the one or multiple reference PC samples comprise a third reference PC sample with the same time stamp as the current frame comprising the current PC sample, or
wherein an indication indicating whether a sample with a later time stamp than the current frame is allowed to be used as a reference PC sample is indicated in the bitstream.

11. The method of claim 1, wherein the current PC sample and the one or multiple reference PC samples are coded in different orders and/or with different coding accuracies, or
wherein PC samples in the point cloud sequence have different coding priorities.

12. The method of claim 11, further comprising:
applying hierarchical coding accuracies to the PC samples based on the coding priorities of the PC samples.

13. The method of claim 12, wherein coding priorities of the one or multiple reference PC samples are higher than the current PC sample, or
wherein coding accuracy of a first PC sample in the point cloud sequence with a higher coding priority is higher than a second PC sample in the point cloud sequence with a lower coding priority, or
wherein coding accuracies of PC samples in the point cloud sequence are controlled by a Quantization Parameter (QP) value or a quantization step in the point cloud sequence coding.

14. The method of claim 13, wherein the QP value or the quantization step for a reference PC sample in the one or more multiple reference PC samples is smaller than that for the current PC sample, or
wherein a delta value of the QP value or the quantization step for a reference PC sample is fixed, or
wherein a delta value of the QP value or the quantization step for the current PC sample is fixed, or
wherein a delta value of the QP value or the quantization step for a reference PC sample is derived at a decoder of the bitstream, or
wherein a delta value of the QP value or the quantization step for the current PC sample is derived at a decoder of the bitstream, or
wherein a delta value of the QP value or the quantization step for a reference PC sample is indicated in the bitstream, or
wherein a delta value of the QP value or the quantization step for the current PC sample is indicated in the bitstream, or
wherein a delta value of the QP value or the quantization step for a reference PC sample is indicated in the bitstream, or
wherein a delta value of the QP value or the quantization step for the current PC sample is indicated in the bitstream.

15. The method of claim 14, wherein the delta value is derived based on at least one of the following:
a size of a GOF,
an intra period or a random access period,
indicators of lossless coding mode, or
indicators of low delay coding mode.

16. The method of claim 11, wherein an indication indicating whether hierarchical QP values and/or QP values or quantization steps are to be used is indicated in the bitstream, or
wherein a QP value for each PC sample in the point cloud sequence is derived at a decoder of the bitstream.

17. The method of claim 1, wherein the conversion includes encoding the current PC sample into the bitstream, or
wherein the conversion includes decoding the current PC sample from the bitstream.

18. An apparatus for processing point cloud data comprising a processor and a non-transitory memory with instructions thereon, wherein the instructions upon execution by the processor, cause the processor to perform acts comprising:
determining, during a conversion between a current point cloud (PC) sample of a point cloud sequence and a bitstream of the point cloud sequence, one or multiple reference PC samples for the current PC sample, wherein at least one reference frame comprising the one or multiple reference PC samples and a current frame comprising the current PC sample are in a group of frames (GOF); and
performing the conversion based on the one or multiple reference PC samples.

19. A non-transitory computer-readable storage medium storing instructions that cause a processor to perform acts comprising:
determining, during a conversion between a current point cloud (PC) sample of a point cloud sequence and a bitstream of the point cloud sequence, one or multiple reference PC samples for the current PC sample, wherein at least one reference frame comprising the one or multiple reference PC samples and a current frame comprising the current PC sample are in a group of frames (GOF); and
performing the conversion based on the one or multiple reference PC samples.

20. A non-transitory computer-readable recording medium storing a bitstream of a point cloud sequence which is generated by a method performed by a point cloud processing apparatus, wherein the method comprises:
determining one or multiple reference point cloud (PC) samples for a current PC sample of the point cloud sequence, wherein at least one reference frame comprising the one or multiple reference PC samples and a current frame comprising the current PC sample are in a group of frames (GOF); and
generating the bitstream based on the one or multiple reference PC samples.
